(19) United States
(12) Patent Application Publication
(10) Pub. No.: US 2018/0165115 A1
(43) Pub. Date: Jun. 14, 2018

(54) SYSTEMS AND METHODS FOR RUNTIME AUTHORIZATION WITHIN VIRTUAL ENVIRONMENTS USING MULTI-FACTOR AUTHENTICATION SYSTEMS AND VIRTUAL MACHINE INTROSPECTION

(71) Applicant: Zentific LLC, Milford, CT (US)

(72) Inventor: Matthew Fusaro, Seymour, CT (US)

(21) Appl. No.: 15/835,407

(22) Filed: Dec. 7, 2017

Related U.S. Application Data
(60) Provisional application No. 62/431,091, filed on Dec. 7, 2016.

(51) Int. Cl. G06F 9/455; G06F 21/44; H04L 29/06

(52) U.S. Cl. CPC G06F 9/45558; G06F 21/44; G06F 2009/45595; G06F 2009/45587; H04L 63/105

(57) ABSTRACT

Systems and methods for runtime authorization within virtual environments using multi-factor authentication (“MFA”) and virtual machine introspection (“VMI”) are provided. The systems and methods utilize MFA to authorize access to branches of system execution during virtual machine introspection.

### CROSS-REFERENCE TO RELATED APPLICATIONS

This application claims the benefit of previously filed U.S. Provisional Patent Application No. 62/431,091, filed on Dec. 7, 2017, entitled “RUNTIME AUTHORIZATION WITHIN VIRTUAL ENVIRONMENTS USING MULTI-FACTOR AUTHENTICATION SYSTEMS AND VIRTUAL MACHINE INTROSPECTION,” which is incorporated by reference herein in its entirety.

### FIELD OF THE INVENTION

The present subject matter is directed to runtime authorization of system access and execution within virtual machines using multi-factor authentication systems, more specifically, to using active virtual machine introspection results to request responses from multi-factor systems to authorize access and execution.

### BACKGROUND OF THE DISCLOSURE

Multifactor authentication (“MFA”) is an access control technique in which a user is required to present more than one form of evidence before being granted the requested access. MFA techniques thereby improve security and increase the time and effort necessary for an attacker to access a system using stolen credentials. Current implementations of MFA typically combine the user's username and password (something the user knows) along with some additional factor of authentication to prove the user is who they say they are (something the user has). This additional factor of authentication can involve another device, passcode, or some additional action after the user's password is verified.

Current multi-factor authentication (MFA) techniques are targeted at users logging into a system or web application. For example, the Time-Based One-Time Password (“TOTP”) and HMAC-Based One-Time Password (“HOTP”) standards implemented in the Red Hat Identity Management system enables a user to have a (hardware or software) token initiated with the Identity Management system. This token rotates a code for the user to concatenate into their password to provide a second factor of authentication when that user logs into a Linux system joined to that Identity Management solution. Another known MFA technique is the RSA SecurID system. RSA SecurID does not rely on concatenation but instead uses a time-based token that is initialized with a seed in the client side hardware or software. The authentication servers have a database of known tokens that verify that the code provided is valid. An application requesting MFA verifies a response from the RSA SecurID system and the user's credentials.

Existing MFA implementations are generally limited to the initial authentication of a user at log in. This can be unsatisfactory in certain situations, such as when additional authorization is desired beyond an initial user login. For example, while a system administrator may grant a user access to a system, the administrator might want to require an additional authorization request before allowing access to certain tasks executed by the user during system execution, processes may launch or terminate, services to start or stop, or access to data on a storage device or received over a network.

### SUMMARY OF THE DISCLOSURE

Systems and methods that enhance security in the context of virtual machine introspection are provided. More specifically, the present subject matter provides additional opportunities for authorization in virtual machine introspection environments. In some embodiments, the present subject matter provides systems and methods that utilize MFA systems for authorizing access to branches of system execution during virtual machine introspection by sending an authorization request to a third party MFA system.

In some embodiments, a method for multi-factor authentication for system execution is provided. The method includes initializing a virtual machine introspection module in a virtual machine environment that includes one or more virtual machines. The virtual machine introspection module monitors the one or more virtual machines for the execution of a pre-defined computer operation that requires additional authorization and only allows the computer operation to proceed when the required authorization is satisfied. Examples of pre-defined computer operations that may be require additional authorization may include the initiation of user processes (e.g., the launching of an executable program); services run under a user's account; or requests for a computer resource, such as a section of code, file, folder, or drive, for example. Monitoring may involve polling one or more critical memory areas or listening for memory or virtual central processing unit (“vCPU”) events, for example.

In some embodiments, a time limit may be set in which the user must provide the required authorization. If the user does not provide the required authorization within the time limit, or provides incorrect authorization evidence, the system can take an action, such as preventing the pre-defined computer operation from executing or re-prompting the user for authentication, for example.

In some embodiments, the method further includes receiving a user MFA input, transmitting the user multi-factor authentication to a third-party multi-factor authentication system, receiving a response from the third-party multi-factor authentication system, and executing or denying execution of the pre-defined computer operation based on the response from the third-party multi-factor authentication system.

The details of one or more implementations are set forth in the accompanying drawings and the description below. Other features and advantages will be apparent from the description and drawings.

### BRIEF DESCRIPTION OF THE DRAWINGS

For a fuller understanding of the inventive embodiments, reference is made to the following description taken in connection with the accompanying drawings in which:

FIG. 1 shows a schematic representation of system 10, in accordance with some embodiments of the present subject matter;

FIG. 2 shows a schematic representation of system 20, in accordance with some embodiments of the present subject matter; and

FIG. 3 shows a flowchart of an exemplary method 300, in accordance with some embodiments of the present subject matter.

### DETAILED DESCRIPTION OF THE DISCLOSURE

Task objects in operating systems run under the context of a particular user. Examples of these task objects include processes started by a user or services run under a user's account. Additionally, tasks might request access to a system resource, such as section of code, a file, a folder, or a drive. A system administrator might wish to require one or more of these task objects or resource requests—particularly those involving sensitive information or potential security risks—to be subject to additional authorization steps at runtime. The present subject matter provides, in some embodiments, an agentless system to invoke a request for additional authorization before allowing such pre-defined operations to be performed on a computer.

The present subject matter provides systems and methods that enable additional authorization for system execution in virtual machine introspection environments utilizing multi-factor authentication (“MFA”). Virtual machine introspection (“VMI”) refers to the interpretation of an operating system (“OS”) or an application memory space extracted from a virtual machine or made available via an application programming interface (“API”) or proxy. In some embodiments, MFA may be used to authenticate access to branches of system execution using virtual machine introspection. In these and other embodiments, the present subject matter provides a system that utilizes MFA responses to verify that an execution that the system is being asked to perform is in fact authorized by the user or administrator.

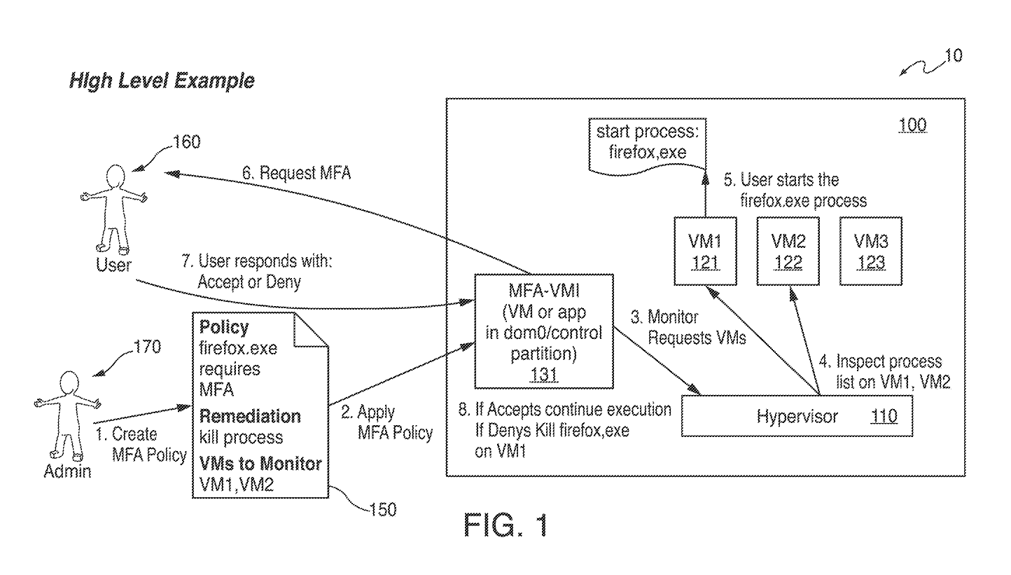

FIG. 1 shows a schematic representation of system 10, in accordance with various embodiments. System 10 includes virtual machine introspection (VMI) environment 100 in which hypervisor 110 is observing a number of virtual machines (e.g., VM1 121, VM2 122, and VM3 123). These virtual machines are shown for illustrative purposes only, there can be fewer or additional virtual machines that are observed by hypervisor 110.

System 10 provides additional authorization by enabling an entity, such as administrator 170 or user 160, for example, to create policy 150, which defines those operations within the observed system (e.g., VM1, VM2, VM3) which will require enhanced authentication before allowing the operation to proceed. Policy 150 may also indicate which virtual machines are subject to the policy. In the example illustrated in FIG. 1, policy 150 requires a MFA response when the process named firefox.exe is started on either VM1 or VM2. In this example, the policy ignores VM3, which is not subject to the policy. Thus, when an instance of firefox.exe is started on VM1 or VM2, MFA-VMI module 131 requests MFA evidence from user 160.

In some embodiments, policy 150 can also include one or more remediation actions. A remediation action can include one or more instructions to be carried out when the user fails to supply the required MFA evidence and/or when the additional factor times out. A timeout can happen if the user does not respond to the request in the pre-configured timeout period. In the example illustrated in FIG. 1, if user 160 fails to provide the requested authorization, MFA-VMI module 131 instructs the proper virtual machine to kill the process. On the other hand, if user 160 provides the required authorization evidence, then execution continues normally.

In the embodiment depicted in FIG. 1, an MFA system (i.e. the entity that actually authenticates the evidence received from user 160) is embedded within MFA-VMI module 131. Accordingly, the MFA request can be sent directly from VMI environment 100 to the user, and the components of VMI environment 100 can receive and act upon the response.

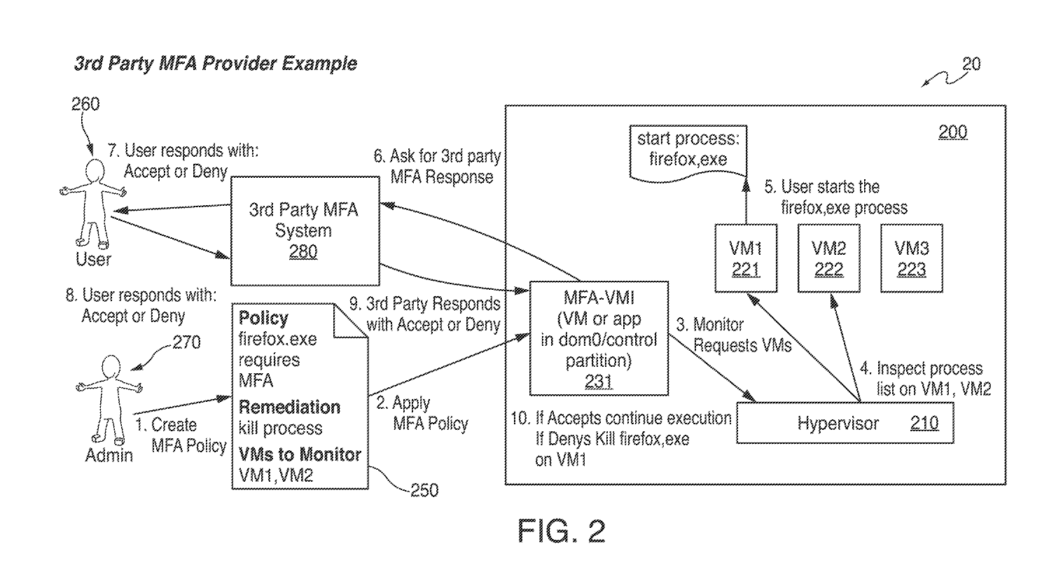

FIG. 2 shows a schematic representation of system 20, in accordance with various embodiments. System 20 is similar to system 10 of FIG. 1, except that it includes a third party MFA system 280. It should be understood that system 20 may enable the use of more than one third party MFA system to request MFA from a user. Third party MFA system 280 can be configured to receive information about a user or group of users that requires the multi-factor authentication. Third party MFA system 280 can also receive metadata about what application or execution category each request belongs to, for example, to assist the third party multi-factor system(s) in differentiating the source of the multi-factor request so that the third-party multi-factor system(s) can apply its own policies and workflows appropriately. Third parties that may provide MFA include RSA SecurID and Duo, for example.

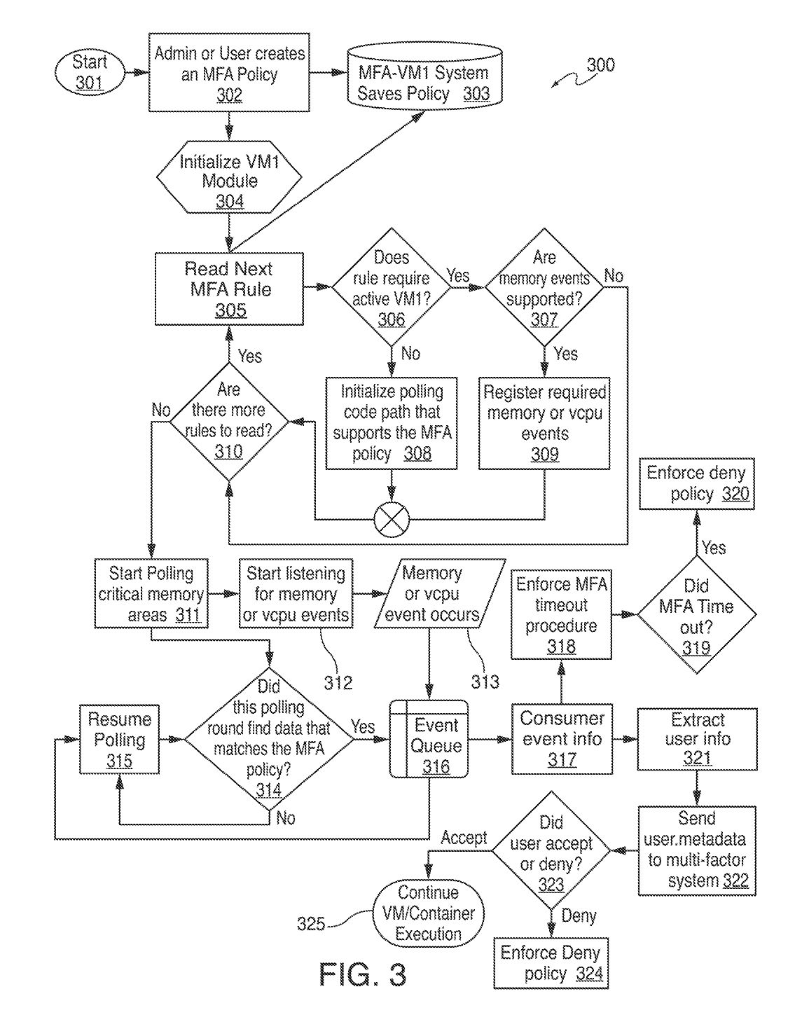

FIG. 3 shows a flow diagram of an exemplary method 300 for providing multi-factor authentication for virtual machine introspection. At 302, the MFA-VMI system allows an administrator or user to create a multi-factor authentication policy. The policy can include a list of pre-defined operations which, when executed on an observed virtual machine, require MFA response. The policy may also define which monitored virtual machines are subject to the policy and/or any remediation actions for a failed authentication attempt. The system consumes and stores the policy with the MFA-VMI system at 303.

When an observed target is available or started (in the case of a container or VM), the MFA-VMI system, at 304, initializes the virtual machine introspection module that can interpret the specific system that is running. For example, if the target is a Microsoft Windows Server 2012r2 virtual machine, it will load the code necessary to interpret the structures created in memory by the operating system kernel. The MFA-VMI system can also optionally introspect user level applications.

At 305, the MFA-VMI system processes each rule in the policy that was stored. For each rule, the system checks whether the rule requires active VMI (306). If no active VMI is required, the system initializes a polling code path that supports the MFA policy (308) and proceeds to check if there are more rules to read (310). If active VMI is required, the system checks whether memory events are supported (307). If supported, the system registers required memory or vCPU events (309) and proceeds to check if there are more rules to read (310). If memory events are not supported, the system checks if there are more rules to read (310).

Once all the rules have been read, the system can start polling critical memory areas (311), and listen for memory or vCUP events (312) and/or check whether each polling round finds data that matches the MFA policy. When the polling round finds data that matches the MFA policy or when memory or vCPU event occurs (313), the event is put into an event queue (316). Information regarding the event is consumed by the system at 317. Based on that information, the system can, for example, enforce MFA timeout procedure at 318 and check whether there was a MFA timeout (319). If so, the system can execute the appropriate instructions (e.g., enforce deny policy at 320). If the event information includes user information, the system can extract that user information at 321, send user metadata to a multi-factor system at 322, and check whether the user accept or deny the required multi-factor authentication at 323. If the user provides the requested authentication evidence (and thereby satisfies the required multi-factor authentication), the system can continue the VM/container execution at 325. If, however, the user fails to provide the requested authentication evidence (and is thereby unable to satisfy the required multi-factor authentication), the system can enforce the deny policy at 324.

In some embodiments, if the policy requires either instrumentation of the memory, memory protection rules (“EPT”), vCPU register activity notifications, or any other supported event delivery mechanism implemented by a hypervisor, debugger, or container system, then the system can initialize the required event listeners and register for these events.

In some embodiments, an alternative branch is provided to use polling (on some configured interval) to scan important data structures in memory for the presence of patterns or structures that require MFA for their presence to be authorized.

When either a polling or event based situation is matched to the policies in the MFA system, an internal event can be delivered to an event queue so the MFA system can process MFA requests. In some embodiments, the present subject matter can consume an event in the queue and send it either to an internal or third-party MFA system that manages the delivery of multi-factor requests and manages keys, passwords, security tokens, biometric data, etc.

When the present subject matter receives a response back (or timeout) from the multi-factor challenge-response component, it can take one of three actions. If there is a timeout, the system can enforce the timeout action specified in the policy (for example, enforce deny policy 320). If the pre-defined operation is denied, then the system can enforce the deny action specified in the policy (324). If an accept response is received by the system, the execution can continue on and no intervention is required (325).

In some embodiments, the present subject matter can take an active or passive approach to intervene in the execution of a virtual machine to request another form of authentication from the user, in addition to the primary authentication system. In some embodiments, the present subject matter does not require a software application to be installed in the guest operating system and uses virtual machine introspection to accomplish multi-factor authorized system execution.

In some embodiments, when the user successfully completes the multi-factor authentication in the allotted time-out window, execution continues normally. If the user fails to provide the requested MFA evidence or the MFA request times out, the present subject matter can take the appropriate action. For example, in some embodiments, the present subject matter can allow the user to pre-define one or more options that will govern how the system deals with a failed or denied multi-factor authentication. Remedial actions, such as pausing a virtual machine, unloading a module, or stopping a process are some examples of the options that can be taken.

In some embodiments, the present subject can operate in a passive mode in which the system checks, at some polling interval, predefined data structures within the observed system for the presence of objects that an administrator has identified as requiring another factor of authentication. As an example, the system can check for the presence of a process that was marked to need multi-factor authentication in order to start. The current subject matter can traverse the process list in the kernel to compare each process name with a list of pre-defined applications. If there is a match, the system can allow the system in question to continue to operate until it gets a response back. If the action is a successful multi-factor response, then no intervention is initiated. If, however, there is a deny that returns from the multifactor request, the system can carry out the appropriate remediation action in accordance with pre-defined instructions.

In some embodiments, the present subject matter can operate in an active case in which one or more hooks are placed into the system being observed at execution boundaries where the administrator may want to ask for another factor of authentication. These boundaries of execution can be, for example, specific pre-defined code regions, a specific function, a series of functions, an administrator defined pattern of hooks hit, or a violation of permissions set on an address, offset from an address, or page(s) of memory in which an event notification is delivered from a hypervisor.

In some embodiments, a breakpoint can be placed at the file delete function and the path and filename can be read from the corresponding data structure. An example would be the_FILE_OBJECT in the Windows Operation System. If the filename or path is part of a list of objects that require another factor of authentication, the system can request action from the user accessing the object or any other entity that will supply this additional factor.

The systems described herein, or portions thereof, can be implemented as a computer program product or service that includes instructions that are stored on one or more non-transitory machine-readable storage media, and that are executable on one or more processing devices to perform or control the operations described herein. The systems described herein, or portions thereof, can be implemented as an apparatus, method, or electronic system that can include one or more processing devices, parallel processing devices, and memory to store executable instructions to implement various operations.

It should be understood that the aspects, features and advantages made apparent from the foregoing are efficiently attained and, since certain changes may be made in the disclosed inventive embodiments without departing from the spirit and scope of the invention, it is intended that all matter contained herein shall be interpreted as illustrative and not in a limiting sense.

What is claimed is:

1. A method for providing runtime authorization within virtual environments, the method comprising:
storing a multi-factor authentication policy in storage of a virtual machine introspection system;
initializing a virtual machine introspection module of the virtual machine introspection system to interpret a virtual machine;
determining a method for monitoring events associated with each rule in the multi-factor authentication policy;
monitoring for the events using the determined methods;
comparing monitored events against the multi-factor authentication security policy; and
when a monitored event triggers a multi-factor authentication response, enforcing multi-factor authentication before executing an operation associated with the monitored event.

2. The method of claim 1, wherein the multi-factor authentication policy comprises a list of pre-defined operations that require multi factor authentication.

3. The method of claim 1, wherein determining a method for monitoring events associated with a rule in the multi-factor authentication policy comprises:
determining whether the rule requires active virtual machine introspection; and
if the rule does not require active virtual machine introspection, initializing a polling path that supports the multi-factor authentication policy.

4. The method of claim 1, wherein determining a method for monitoring events associated with a rule in the multi-factor authentication policy comprises:
determining whether the rule requires active virtual machine introspection;
if the rule does require active virtual machine introspection, determining whether memory events are supported; and
if memory events are supported, registering one of a memory and a vCPU event to be monitored.

5. The method of claim 1, further comprising:
logging monitored events into an event queue.
